(19) United States
(12) Patent Application Publication
(10) Pub. No.: US 2012/0304871 A1
(43) Pub. Date: Dec. 6, 2012

(54) DEEP FRYER

(75) Inventor: Chiat Gee Chen, Dannemora (NZ)

(73) Assignee: Shu Ling YONG, Auckland (NZ)

(21) Appl. No.: 13/577,630

(22) PCT Filed: Feb. 8, 2011
(86) PCT No.: PCT/NZ11/00016

§ 371 Date: Aug. 7, 2012

(30) Foreign Application Priority Data
Feb. 8, 2010 (NZ) 583168

(51) Int. Cl. A47J 37/12

(52) U.S. Cl. 99/408

(57) ABSTRACT

A deep fryer to fry food includes a fryer housing to contain oil and water, heating element, cooling element, water draining element and oil draining element. A lower portion of the deep fryer contains water and an upper portion contains oil whereby the side walls of the housing are angled towards each other. The cooling element includes a cooling tunnel located within the side walls of the housing and a baffle including rails located in the oil restricting a lower portion of the oil being circulated in the housing. A cooling apparatus is connected to the cooling tunnel so air can be pushed or pulled there through, to cool a lower part of the oil in the upper portion whereby to allow any scraps or waste from the cooked food to fall down to the bottom end of the housing to be expelled or removed from the deep fryer.

The invention relates to a deep fryer for frying food as used in commercial or domestic cooking and to a method of installation. The invention is directed particularly but not solely towards a deep fryer for cooking in oil.

### BACKGROUND OF INVENTION

Typically deep fryers are used for frying takeaways or in many commercial cooking operations. Oil is preferred in this type of cooking because of the taste it adds to any cooked product. Some disadvantages with cooking with oil are, cost and health concerns. Oil is costly to purchase and difficult to dispose of after use. So the less oil you can use, the less you need to buy and dispose of. In terms of current public health and environmental concerns, there is also pressure to use less oil and to make sure it is the best oil.

Another difficulty with oil is that cooking with oil can be dangerous, as the oil used in a deep fryer can be extremely hot and difficult to control temperature wise.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT OF THE INVENTION

It is an object of the invention to provide an improved deep fryer that ameliorates some of the disadvantages and limitations of the known art or at least provide the public with a useful choice.

### SUMMARY OF INVENTION

In a first aspect the invention resides in a deep fryer comprising a fryer housing adapted to contain oil and water, heating means, cooling means, water draining means and oil draining means whereby the fryer is connectable to a suitable power source to cause the oil to be heated accordingly, wherein the fryer housing has a body having a shape including an upper end and lower end with walls forming sides and a recess within to define a lower portion adapted for containing water and an upper portion adapted to contain oil, the lower portion including the water draining means and the upper portion including the oil draining means wherein the cooling means is located underneath or below the heating means and the cooling means includes at least one hollow cooling tunnel extending from one side of the fryer housing to the other and a cooling apparatus, whereby the cooling apparatus is operatively connected to the cooling tunnel such that in use, air is able to travel or be pushed or pulled there through, to cool a lower part of the oil in the upper portion, wherein the cooling tunnel is formed as part of the sides of the housing, the sides of the housing are angled towards each other such that the lower end is of less width than the upper end and the deep fryer includes a baffle comprising rails removably located within the oil to cause when the cooling means is activated, the circulation of oil to be restricted somewhat and the temperature in a lower portion of the oil to drop to be cooled somewhat which also slows down any oil movement to allow the scraps or waste to fall down to the bottom end of the housing or water to be eventually expelled or removed from the fryer.

Preferably the rails of the baffle are horizontally supported and connected to end plates whereby the end plates are positioned in the front and rear of the housing to cause the rail to be parallel to the sides of the housing.

Preferably there are two rows of spaced rails wherein there is first row of rails located above a second row of rails, each rail is spaced from the other in side to side gaps and upper and lower relationship spacings, and the second row has less rails in number than the first row, and the rails are spaced in a staggered pattern whereby each rail has a cross sectional shape to be an inverted V shape when in use, whereby the gaps from row to row form a tortuous path.

Preferably the baffle is positioned in the housing whereby a border line between the oil and water, is located below the second row.

Preferably, the cooling means includes a cooling housing fluidly at least connecting one end of the said at least one hollow tunnel, with the cooling apparatus connected to the cooling housing whereby the cooling apparatus operates to push or pull air there through the hollow tunnel.

Preferably, the cooling means includes a plurality of cooling tunnels comprising a series of tubular structures located at a certain height from the upper end or bottom end of the fryer housing.

Preferably, a viewing means is located below the second row of rails, the oil draining means is located at a similar level to the viewing means and the water draining means is located at the bottom end of the fryer housing or the bottom of the lower portion or of the water.

Preferably, the fryer housing is supported by a supporting means which is in the form of a frame.

Preferably, the viewing means includes a level indicating means which is in the form of at least one window comprising a protruding tube having at least one viewing end able to allow the viewing of the level of water or oil within the tank recess.

Preferably the oil draining means can be combined with a viewing means whereby there is a horizontally extending protruding tubular member from the inside of the fryer housing such that the oil draining means is formed as a downwardly protruding outlet.

Preferably, the heating means includes at least one removable heating element able to be, inserted and positioned into the oil and to be removed if required.

Alternatively the heating means includes at least one heating tunnel which is adapted to be heated or able to have heat applied to it.

Preferably, the cooling housing includes a partially enclosed space surrounding at least one end of the at least one cooling tunnel and the cooling housing having venting means and at least one fan operatively connected to push or pull air through the at least one cooling tunnel.

In a second aspect the invention resides in a method of preparing or commissioning a deep fryer as disclose d above for use wherein the method includes the steps of:
close the oil and water draining means 25 and 26;
locate and fill the tank recess 3 with water 4 until the water level firstly shows in the viewing means;
locate suitable cooking oil and pour into the tank recess over the top of the water;
rotate the heating means down into the oil;
turn on the heating means to a certain temperature and
turn on the cooling means to a certain temperature which then causes the temperature in a lower portion of the oil to drop to be cooled somewhat which slows down any oil movement to allow the scraps or waste etc to fall down to the bottom end of the water to be eventually expelled or removed from the fryer.

Preferably for an electrically operated fryer, after closing the draining means, rotate heating means out of way of the tank recess.

In a third aspect the invention resides in a method of draining or decommissioning the fryer apparatus, one can carry out the following steps:
turn off the heating means and the cooling means;
open an oil draining means to then drain off the oil;
remove any unwanted food scraps or waste;
close off oil draining means and refill or optionally after draining the oil and removing any scraps, the water draining means can be opened to drain off the water out,
after this new water or cleaned water can be put in followed by new or cleaned oil.

### BRIEF DESCRIPTION

The invention will now be described, by way of example only, by reference to the accompanying drawings:

FIG. 1 is a schematic cross section of the deep fryer in accordance with a first preferred embodiment of the invention.

FIG. 2 is a schematic side cross sectional view of the gas deep fryer.

FIG. 3 is a schematic top plan view of the gas deep fryer.

FIG. 4 is a schematic rear cross sectional end view of the gas deep fryer.

FIG. 5 is a schematic side cross sectional view of the electric deep fryer.

FIG. 6 is a schematic top plan view of the electric deep fryer.

FIG. 7 is a schematic side cross sectional view of the electric deep fryer—with the elements uplifted.

FIG. 8 is a schematic rear cross sectional end view of the electric deep fryer.

FIG. 9 is a cross section of a baffle.

FIG. 10 is side view of the baffle of FIG. 9

FIG. 11 is another cross section of the baffle of FIG. 9 but with viewing means & outlet.

FIG. 12 is a top plan view of the baffle.

FIG. 13 is perspective view of the baffle

FIG. 14 is a cross sectional side view of the baffle in the deep fryer

FIG. 15 is a top view of the baffle without the heating means in place in the fryer.

FIG. 16 is a front or rear view of the baffle in the deep fryer

FIG. 17 is a side view of the baffle in the deep fryer

FIG. 18 is a top view of the baffle with heating means in the deep fryer

FIG. 19 is a side view of the baffle with various outlets and heating means not fully inserted into the deep fryer.

### DESCRIPTION OF DRAWINGS

The following description will describe the invention in relation to preferred embodiments of the invention, namely a deep fryer. The invention is in no way limited to these preferred embodiments as they are purely to exemplify the invention only and that possible variations and modifications would be readily apparent without departing from the scope of the invention.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be limiting.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However it is to be understood that the invention may assume various alternative variations, except where expressly specified to the contrary. It is also to be understood that the specific devices illustrated in the attached drawings, and described in the following specification are simply exemplary embodiments of the invention. Hence specific dimensions and other physical characteristics related to the embodiments disclosed herein are not to be considered as limiting.

FIGS. 2-4 show various cross sectional view of a gas operated deep fryer and FIGS. 5-8 show cross sectional views of an electrically operated gas fryer. Essentially the electrically operated gas fryer operates with a removable heating means and with a cooling means located higher in the fryer housing than the cooling means for the gas operated fryer. The heating means in a gas operated fryer does not use a removable heating element but relies on heating tube(s).

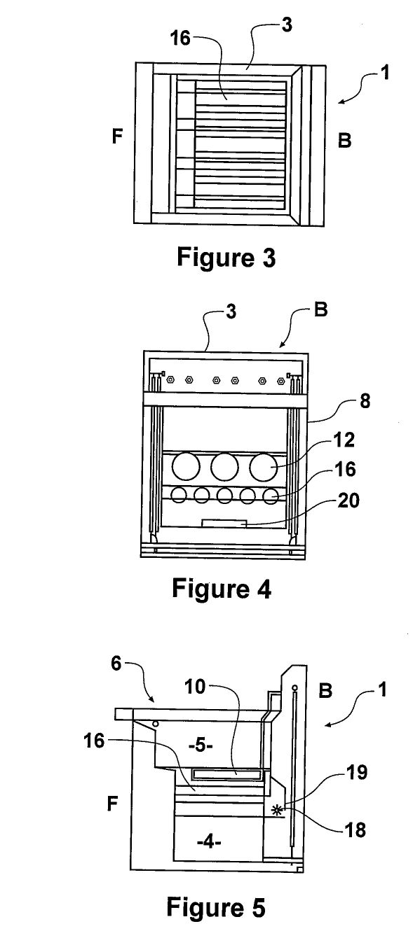

FIGS. 1-8 show a deep fryer 1 of the present invention which comprises body in the form of a fryer housing 2 with a recess 3 therein adapted to contain and water 4 and oil 5. In use the fryer housing 2 comprises a fryer tank having an upper end 6, lower end or base 7, with side walls 8, a front F and back B. The deep fryer also has power means (not shown), whereby the body is adapted to allow it to be heated or cooled to certain temperatures whereby the water 5 is located at the lower end of the recess and the oil 5 is at the upper end.

The water is said to be located at a lower portion 9 of a total depth 9; depth 9A of the recess 3 and the oil is located in an upper portion 9B above the water. Also there will be a space or depth 9C having no oil or water. This empty space 9C is located at the top of the recess 3.

The fryer 1 includes a heating means 10 is located at an upper end within the oil 5 which allows the oil 5 to be heated accordingly.

The heating means for the electrically operated fryer (FIGS. 5-8) comprise movable heating coil element or elements 10 which are operatively connected to the housing to allow the heating means to be rotatably or hingedly supported by hinging means 11 and rotated into and out of the oil 5 to allow heating and to allow cleaning or access when required. In this example the hinging means includes biasing means which can be for example two springs extending from top to bottom on each side of housing 2, to allow the heating means to be rotated up and out of the fryer or oil as shown in FIG. 7 in the electric deep fryer version.

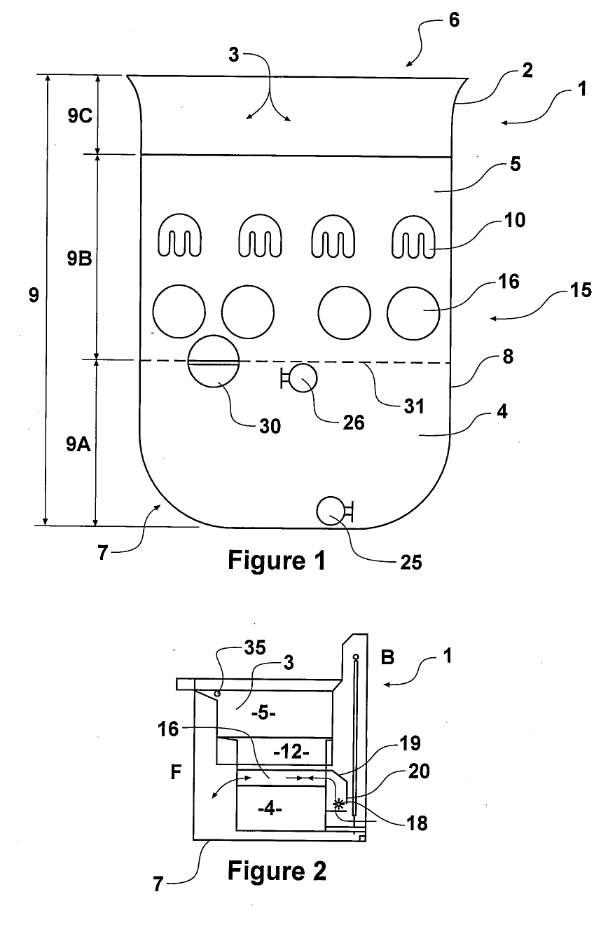

As shown in FIGS. 2-4 instead of a rotating heating means 10 as for the electrically operated fryer, the gas operated fryer includes at least one heating tube 12.

Also the fryer 1 includes a heat exchanging or cooling means 15 which is located within the recess 3 below the heating means 10 and surrounded by the oil 5 but in a lower position as shown in FIG. 1. The cooling means includes hollow tubular cooling tunnel(s) 16 extending from front to back of the housing with there being ends 17. Also the cooling means includes cooling apparatus 18 and cooling housing 19. In use the cooling tunnels and heating means are directly surrounded or immersed by the oil and or water.

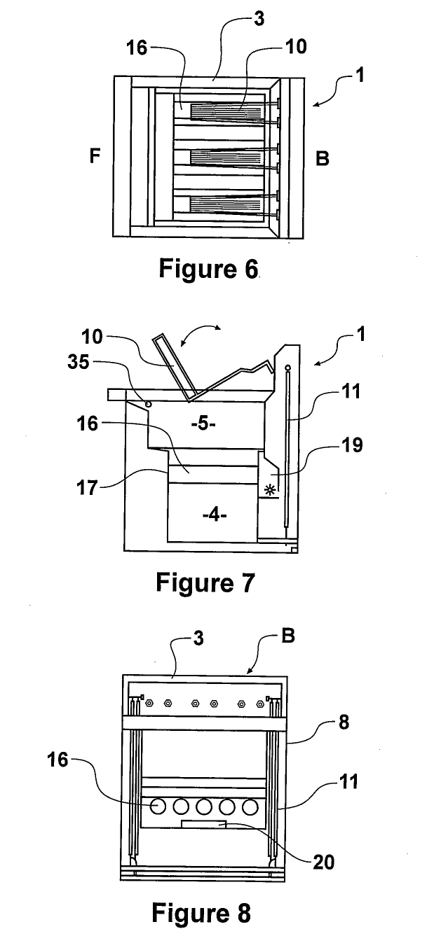

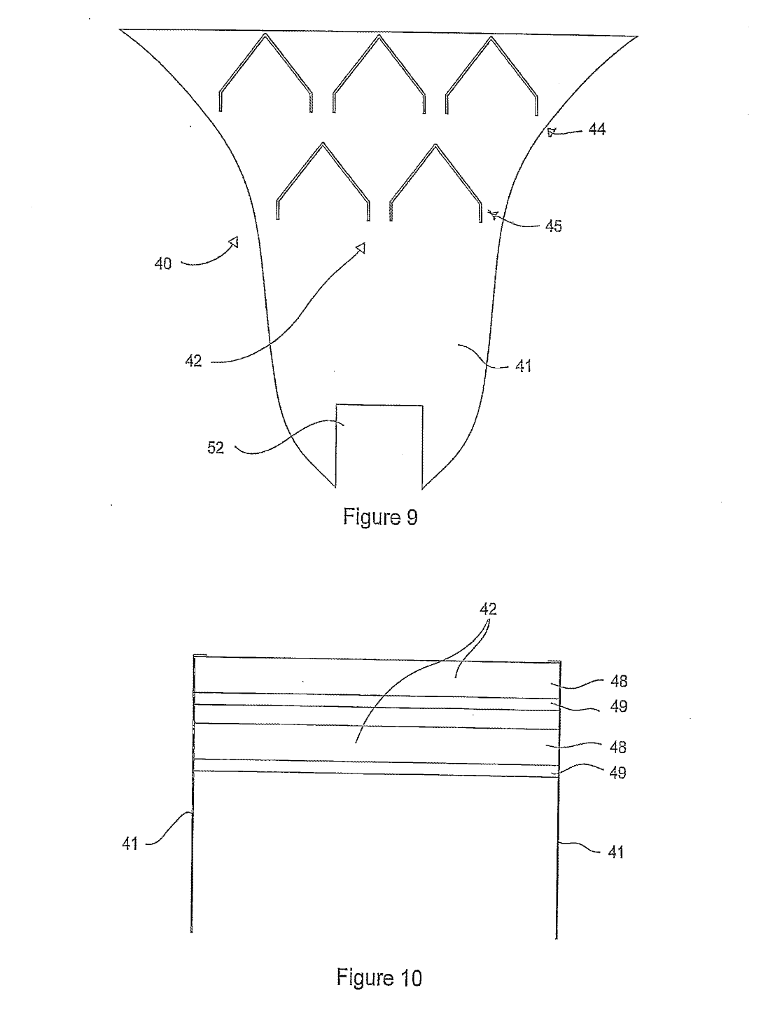

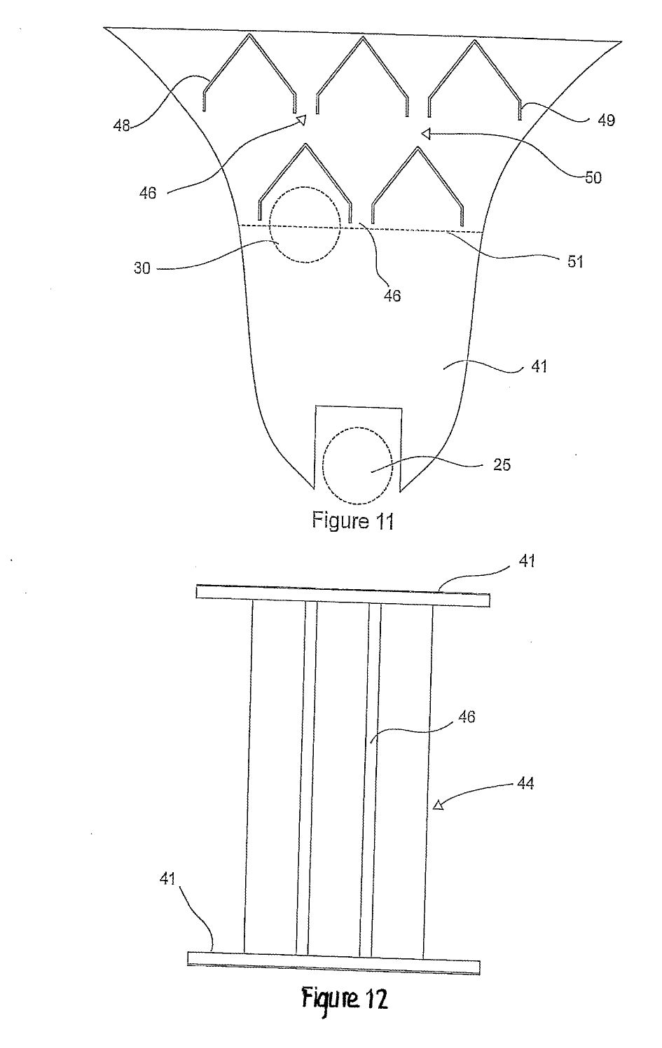

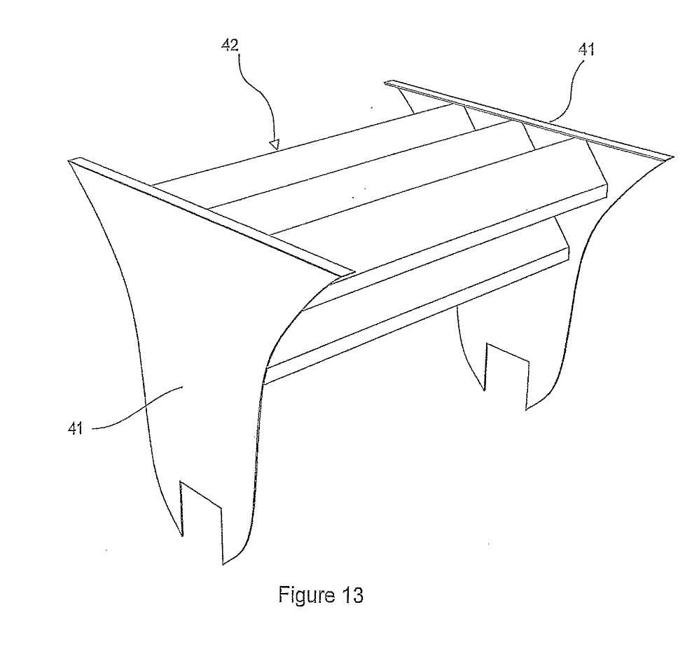

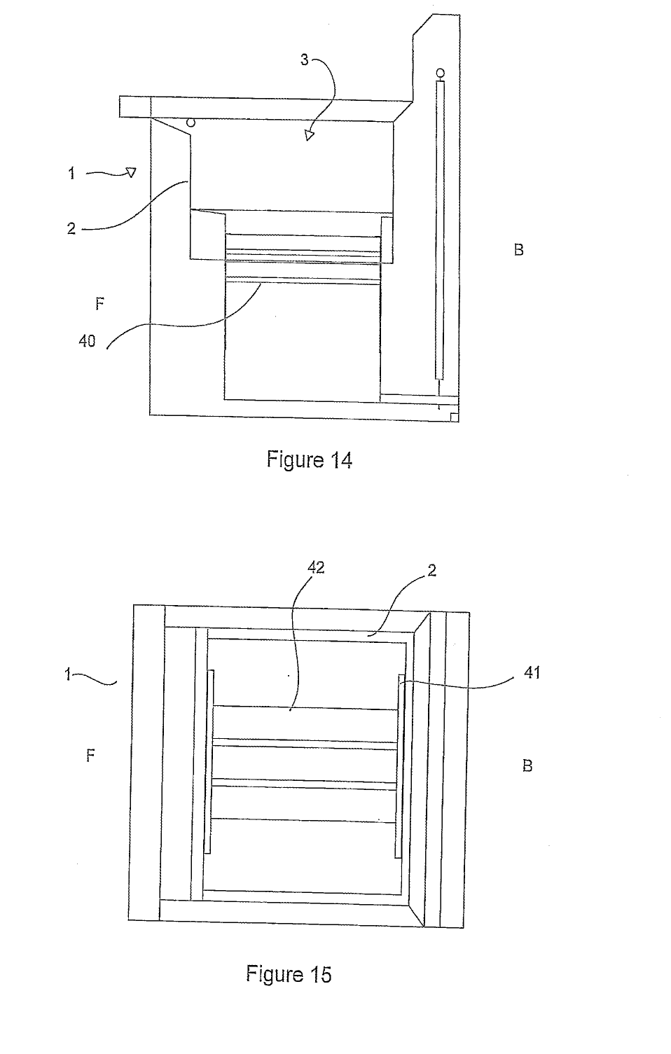

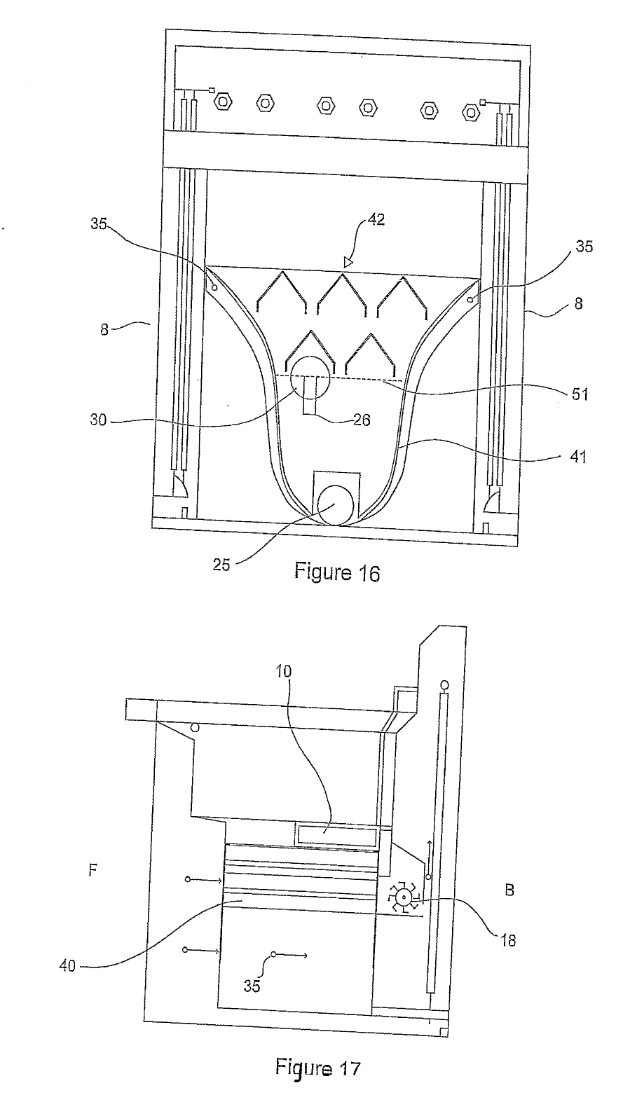

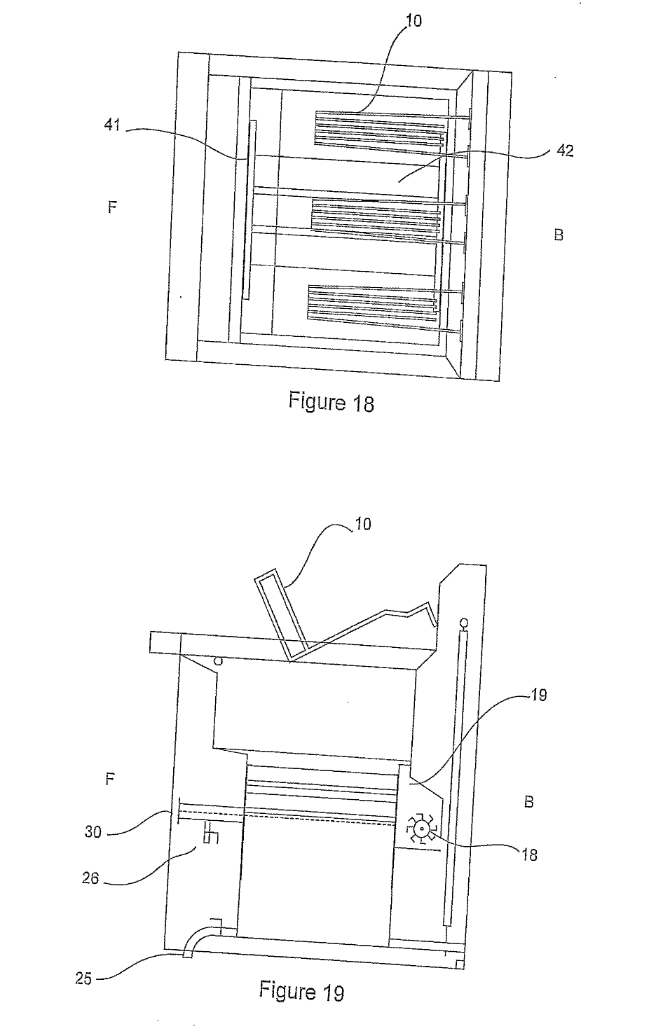

Cooling housing 19 is located on the front/back or sides 8, to be fluidly joined to the ends 17 of the cooling tunnels whereby the cooling apparatus 18 is located within the cooling housing 19. The cooling apparatus 18 can be at least one fan (for example a AC fan crossflow), which can suck or blow air through the cooling tunnels 16. As shown in the figures the cooling means is shown as extending from front to back of the fryer but equally other positions and combinations in the fryer housing 2 are also possible. Housing 19 is located at, at least one end of the tunnels 16 consisting of a verandah roof portion and base portion whereby venting means 20 (see FIGS. 4 and 8) has also been provided. The venting means 20 can be for example as shown in FIGS. 4 and 8, be a single centrally located aperture of any shape, or a plurality of apertures of any shape and spacing.

As shown in the schematic FIG. 1, fryer housing 2 has draining means which is in the form of a first draining means or water draining means 25 for the water which is located at the lowest portion 9 of the housing. There is also a second draining means or oil draining means 26 for draining the oil 5 from within the recess or housing. The oil draining means 26 is located just below the cooling tunnels 16 at the lowest point in the oil 5 which still allows all of the oil 5 to be drained out. The water draining means 25 is located at the base 7 or lowest point within the water 4. Each draining means 25 and 26 can consist of at least one tubular protruding portion with any suitable opening and closing means like for example a manual moveable lever gate valve.

A viewing means 30 can be formed as part of the fryer 1 as shown in FIG. 1 which is located at a border or level 31 between the oil and water 4. The viewing means 30 comprises a viewing end fluidly sealed and see through to providing level indicating means eg of glass which extends within and beyond if required, of the oil and/or water. The viewing means 30 is located almost on the same level as the oil draining means 26 so that the viewing means 30 is used to allow one to follow the filling of the water to a correct upper level within the tank.

The viewing means 30 can comprise any material, like glass or plastic for example that at least allows the levels of oil and/or water to be seen. The fryer 1 can also have overflow means 35 and moving means (not shown) which can be in the form of any means such as wheels or rollers, that can allow at least one fryer to be moved or be portable or transportable.

During the operation of the fryer 1, ie during the heating by the heating means 10 and 12, the oil is heated to a certain temperature which causes the oil to bubble and move or agitate all of the contained oil, to cause a sort of circulation of oil in the recess. The agitating oil can be useful in causing any food or scraps/waste/sediment within the oil to be continually moving as well. However when the cooling means is activated this causes the temperature in a lower portion 9B of the oil to drop to be cooled somewhat which slows down any oil movement to allow the scraps or waste etc to fall down to the bottom end of the water to be eventually expelled or removed from the fryer 1.

To fill or commission or prepare the fryer for use one can carry out the following steps of:
close oil and water draining means 25 and 26;
rotate heating means out of way of the recess 3;
locate and fill the tank recess 3 with water 4 until the water level or border 31 shows in the viewing means 30;
locate suitable cooking oil 5 and pour into the recess 3 over the top of the water 4;
for the electric fryer, rotate the heating means 10 down into the oil 5;
turn on heating means 10 or 12 to a certain temperature and
turn on cooling means to a certain temperature

To drain or decommission the fryer apparatus one can carry out the following steps:
turn off heating means 10 or 12 and cooling means;
open oil draining means 26 to then drain off the oil 5;
remove any unwanted food scraps or waste;
close off oil draining means 26 and refill or optionally after draining the oil and removing any scraps,
the water draining means 25 can then be opened to drain off the water, after this new water or cleaned water can be put in followed by new or cleaned oil.

These steps can be varied eg there may be no heating means 10 to rotate or the switching on or off of the heating and cooling can be done at different times.

FIGS. 9-19

As shown in FIGS. 9-16 part of the previously disclosed cooling tunnels 16 are now formed as part of the housing 2, whereby the side walls 8 of the housing 2 are formed creating an enclosed side cooling tunnel 35 whereby air can be directed through by being pushed or pulled or allowed to circulate naturally there through. Cooling tunnel 35 is a space between an inner wall 36 and outer wall 37, which like the cooling tunnels 16 is fluidly connected to cooling apparatus ie a fan 18 which is located at the rear of the housing 2.

As shown in FIG. 16 there can be a cooling tunnel 35 in at least the side walls 8.

The housing 2 is shaped having angled side walls leading down to lower end being of a width less than the width of the top part of the housing. In this example the side walls 8 can be curved or simply angled towards each other.

Also shown in FIGS. 9-16 the cooling tunnels of FIGS. 1-8 can also be formed including a baffle 40 (see FIGS. 9-13) which includes a baffle frame structure which is designed to be able to be inserted into the housing 2 into a lower portion of the oil as contained in an upper portion of the recess 3 and be removed from the inside of the housing 2 if required to effect cleaning or changing of oil and/or water or removal of food scraps or waste from the bottom of the housing 2.

The baffle frame includes end plates 41 (to provide vertical support) supporting horizontally oriented rails 42 in between. When in use the end plates 41 are shaped to match the angled side walls 8 to enable the end plate 41 to be abutting the side walls 8 of the housing 2 whereby the rails 42 are oriented parallel to the side walls 8 of the housing. As shown there can be three rails spaced from each other at a top of the baffle frame to be called a first row 44 and two rails also spaced from each other to comprise a second row 45 located below the first row 44 and staggered in relation to the first row so that each first row rail 44 is spaced by a gap 46 from an adjacent rail so that the gaps 46 in the first row 44 do not line up with the gap 46 in the second row 45 to form a tortuous path.

There is also a space 50 between the first row 44 and second row 45. The rails are shown as being elongate members having cross section of an inverted triangular shape 48 with edge flanges 49 being parallel with each other. There is a border line or line of separation 51 between the oil as located in an upper portion of the housing 2 and the water as located in a lower portion of the housing 2 so that the baffle 40 is located within the recess of the housing whereby border 51 is position just below the flanges 49 of the second row 45.

Also as shown there can be a viewing means 30 located at border line 51 comprising window of glass or plastic within the front wall F of the housing 2, to enable viewing there through of the water and oil levels. Draining means 26 for the oil can be located adjacent the viewing means 30 and draining means 25 for the water is located at the bottom of the housing. As shown in FIG. 9-16 a bottom part of the end plates 41 can be notched 52 to allow the drainage means 25 to be able to drain the contents without interference.

Advantages
a) Uses less oil
b) Oil lasts longer—less oil changes required
c) Oil is boiled at a lower temperature
d) Safer to use
e) Easier to change oil
f) Easier to install
g) Reduced running costs
h) Existing fryers can also be converted
i) Position of heat exchanger can be varied
j) Oil does not get so dry during its use

Variations

Throughout the description of this specification, the word “comprise” and variations of that word such as “comprising” and “comprises”, are not intended to exclude other additives, components, integers or steps. It will also be understood that where a product, method or process as herein described or claimed and that is sold incomplete, as individual components, or as a “kit of Parts”, that such exploitation will fall within the ambit of the invention.

For the oil, this can be any type of oil 5 that is able to be used in frying or able to be used as a cooking oil. Though water 4 is used with the oil 5, to enable less oil 5 to be used and to cause any scraps or sediment or waste to pass or fall through all the water 4 or its equivalent has to be, the water 4 is heavier than the oil 5 to allow it to be able to sit below the oil 5. Alternatively the oil 5 must be lighter than the non oil or water 4 as it is the relative weight differences between, that are more important. The depth of water 9A or 9B can be varied to suit use and cost.

The fryer 1 can be manufactured to any size or dimensions and of any material that enables the fryer to cook selected products according to both cooking standards and health regulations. For example the housing can be shaped with a curved base or a flat base.

The hollow tunnels or spaces 16 for the cooling means 15 can include at least one hollow space 16 though there can be several such tubular spaces in different directions. This fryer can be used both as a gas or electric operated fryer or even a combination of both. Any number or combination of fryers can be used in parallel or series. The hollow tubular space(s) 16 of the cooling means can be any number, spacing and cross sectional shape or dimension such as circular, square or oval and can be straight or bent in shape from one side to the other. The material for the housing used can be stainless steel or any other material combination able to withstand the heat and meet any health regulations.

There can be fans on either ends of the tunnels and there can be individual fans for each tunnel 16 if necessary. The draining means can include at least one such means or several which can be placed or located anywhere within the recess 3 as required or desired. There can any number of viewing means and draining means 25 and 26. Also the viewing means 30 can be combined with anyone of the draining means 25 or 26 such as the oil draining means 26. This combination could be formed as protruding horizontal tube having viewing through a window with level indicating means, and with a downwardly facing tubular branch to allow drainage therefrom and viewing at the location. There can also be included the overflow means 35 which can also be formed as an in use horizontal outlet at the top of the housing which can be fluidly connected to another container or drain.

It will also be understood that where a product, method or process as herein described or claimed and that is sold incomplete, as individual components, or as a “kit of Parts”, that such exploitation will fall within the ambit of the invention.

The baffle 40 can also be formed as part of the housing 2 or it can be joined or removably connected to the housing 2. The end plates 41 and rails 42 can be formed as separate components which are joined together or can be formed as a one piece item. The shape of the end plates 41 can be formed as matching the internal surface or just touching the sides and base enough to enable suitable support for the rails 42 or the baffle 40 can be formed without end plates 41 whereby the rails 42 can be supported only at their ends or by posts at any suitable position on or under the rails 42.

Though the baffle 40 is shown as being oriented from back to front, other orientations of the baffle 40 in the housing 2 are also possible. Notch 52 is shown as being square shaped though other shapes are equally possible.

The cavity 35 can be formed as extending over the whole area of the side walls or it can be formed only as a portion. The deep fryer can also work without water thereby not necessarily needing the baffle 40.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

These and other features and characteristics of the present invention, as well as the method of operation and functions of the related elements of structures and the combination of parts and economics of manufacture, will become more apparent upon consideration of the following description with reference to the accompanying drawings, all of which form part of this specification, wherein like reference numerals designate corresponding parts in the various figures.

1-15. (canceled)

16. A deep fryer for frying food comprising a fryer housing adapted to contain oil and water, heating means, cooling means, water draining means and oil draining means whereby the fryer is connectable to a suitable power source to cause the oil to be heated accordingly, wherein the fryer housing has a body having a shape including an upper end and lower end with walls forming sides and a recess within to define a lower portion adapted for containing water and an upper portion adapted to contain oil, the lower portion including the water draining means and the upper portion including the oil draining means wherein the cooling means is located underneath or below the heating means and the cooling means includes at least one hollow cooling tunnel extending from one side of the fryer housing to the other and a cooling apparatus, whereby the cooling apparatus is operatively connected to the cooling tunnel such that in use, air is able to travel or be pushed or pulled there through, to cool a lower part of the oil in the upper portion, wherein the cooling tunnel is formed as part of the sides of the housing, the sides of the housing are angled towards each other such that the lower end is of less width than the upper end and the deep fryer includes a baffle comprising rails removably located within the oil to cause when the cooling means is activated, the circulation of oil to be restricted and the temperature in a lower portion of the oil to drop to be cooled which also slows down any oil movement to allow scraps or waste from frying to fall down to the bottom end of the housing to be expelled or removed from the deep fryer.

17. The deep fryer as claimed in claim 16 wherein, the cooling means includes a cooling housing fluidly at least connecting one end of the said at least one hollow tunnel, with the cooling apparatus connected to the cooling housing whereby the cooling apparatus operates to push or pull air there through the hollow tunnel.

18. The deep fryer of claim 17 wherein the rails of the baffle are horizontally supported and connected to end plates whereby the end plates are positioned in the front and rear of the housing to cause the rail to be parallel to the sides of the housing.

19. The deep fryer of claim 18 wherein there are two rows of spaced rails wherein there is first row of rails located above a second row of rails, each rail is spaced from the other in side to side gaps and upper and lower relationship spacings, and the second row has less rails in number than the first row, and the rails are spaced in a staggered pattern whereby each rail has a cross sectional shape to be an inverted V shape when in use, whereby the gaps from row to row form a tortuous path.

20. The deep fryer of claim 19 wherein the baffle is positioned in the housing whereby a border line between the oil and water, is located below the second row.
